(19) United States
(12) Patent Application Publication
(10) Pub. No.: US 2011/0150278 A1
(43) Pub. Date: Jun. 23, 2011

(54) INFORMATION PROCESSING APPARATUS, PROCESSING METHOD THEREOF, AND NON-TRANSITORY STORAGE MEDIUM

(75) Inventor: Tomoyuki Shimizu, Yokohama-shi (JP)

(73) Assignee: CANON KABUSHIKI KAISHA, Tokyo (JP)

(21) Appl. No.: 12/949,571

(22) Filed: Nov. 18, 2010

(30) Foreign Application Priority Data
Dec. 18, 2009 (JP) 2009-288417

(51) Int. Cl. G06K 9/00

(52) U.S. Cl. 382/103

(57) ABSTRACT

An information processing apparatus comprising: a storage unit configured to store image features of multiple targets and mutual relationship information of the multiple targets; an input unit configured to input an image; a detection unit configured to detect a region of a target from the input image; an identification unit configured to, based on the stored image features and image features of the detected region, identify the target of the region; and an estimation unit configured to, in the case where both a first region in which a target was identified and a second region in which a target could not be identified are present in the input image, estimate a candidate for the target in the second region based on the mutual relationship information and the target in the first region.

### BACKGROUND OF THE INVENTION

1. Field of the Invention

The present invention relates to techniques for estimating a target object that cannot be identified in an image.

2. Description of the Related Art

Due to the recent spread of digital still cameras and the like, large amounts of digitized image data are being accumulated. Accordingly, there is an increased demand for techniques that search for images, organizing images, and so on with ease.

Conventionally, images have been searched for, organized, and so on using relation information such as a date/time, parameters of the shooting device, and so on added to images by the shooting device at the time of shooting (called “metadata” hereinafter). However, this metadata is not easy to remember, and it is thus often difficult to find images based on metadata. Therefore, it is desirable to also add metadata that uses the name of the subject or the like to the image in order to enhance the ease of use for users.

Thus far, metadata such as the name of the subject or the like has been input by a user him or herself carrying out that input. However, as mentioned earlier, the number of images that are being accumulated is increasing, and thus sequentially inputting such metadata by hand is troublesome.

In light of this, techniques to identify subjects in an image, and in particular, facial recognition processing techniques that extract a feature amount of a person's face and identify that person, are being developed and continue to be put into practical use. In, for example, the technique disclosed in Japanese Patent Laid-Open No. 9-251534, which discusses a typical facial recognition process, facial feature amounts, such as the eyes, nose, mouth, and the like of people to be identified are calculated in advance through resolution filtering and comparison with template patterns, and the calculated feature amounts are then stored. An individual is then identified by comparing these with an input facial feature amount to be identified. Through this, it is possible to automatically add information of the person shown in the image to that image.

However, in this conventional typical facial recognition process, a sufficient degree of identification precision cannot be obtained in the case where the constituent elements of the face (the eyes, the nose, the mouth, and so on) that are necessary for the calculation of the facial feature amounts cannot be extracted in an accurate manner, making it impossible to identify the face. For example, in the case where the face is looking to the side or away instead of to the front, the case where the subject is posing and part of the subject's face is hidden by the subject's hand, and so on, problems have occurred in such facial identification.

Furthermore, if there are large differences between feature amounts, a drop in precision or an erroneous identification may occur even in the case where the calculation of the facial feature amounts was carried out correctly. For example, a case in which facial feature amounts have changed over time can be considered. In particular, in a case of children, facial constituent elements change more significantly that adults due to growth, and therefore differences from the feature amounts are likely to occur.

In addition, depending on the method by which the feature amounts are found, a drop in precision or an erroneous identification may even be caused by changes that occur on a daily basis and with high frequency, such as changes in a subject's hairstyle, whether or not the subject is wearing glasses, and so on.

There have thus been situations where a target object cannot be identified and personal information cannot be added to an image in cases where, for people, a sufficient degree of precision cannot be achieved in the facial recognition process, problems occur in the facial identification, and so on.

### SUMMARY OF THE INVENTION

The present invention provides a technique for adding information of a target object that can be estimated more accurately, for images in which the target object could not be identified.

According to a first aspect of the present invention there is provided an information processing apparatus comprising: a storage unit configured to store image features of multiple targets and mutual relationship information of the multiple targets; an input unit configured to input an image; a detection unit configured to detect a region of a target from the input image; an identification unit configured to, based on the stored image features and image features of the detected region, identify the target of the region; and an estimation unit configured to, in the case where both a first region in which a target was identified and a second region in which a target could not be identified are present in the input image, estimate a candidate for the target in the second region based on the mutual relationship information and the target in the first region.

According to a second aspect of the present invention there is provided a processing method for an information processing apparatus, the method comprising: inputting an image; detecting a region of a target in the input image; identifying a target in the region based on image features of multiple targets stored in a storage unit that stores the image features and mutual relationship information of the multiple targets, and based on image features of the detected region; and estimating, in the case where both a first region in which a target was identified and a second region in which a target could not be identified are present in the input image, a candidate for the target in the second region based on the mutual relationship information and the target in the first region.

Further features of the present invention will be apparent from the following description of exemplary embodiments (with reference to the attached drawings).

### BRIEF DESCRIPTION OF THE DRAWINGS

The accompanying drawings, which are incorporated in and constitute a part of the specification, illustrate embodiments of the invention, and together with the description, serve to explain the principles of the invention.

FIG. 1 is a block diagram illustrating a circuit arrangement according to an embodiment of the present invention.

FIG. 2 is a block diagram illustrating a basic configuration according to an embodiment of the present invention.

FIG. 3 is a flowchart illustrating the procedure of a process for finding mutual relationships between people, according to an embodiment of the present invention.

FIG. 4 is a flowchart illustrating the procedure of a process for estimating, based on mutual relationships between people, a person that could not be identified, according to an embodiment of the present invention.

FIG. 5 is a diagram illustrating an example in which a table that holds mutual relationships between people is updated according to an embodiment of the present invention.

FIG. 6 is a diagram illustrating the determination of cutoff points of image shooting times and the grouping of images into events, according to an embodiment of the present invention.

FIG. 7 is a diagram illustrating an image group for which mutual relationships of people are registered and that also illustrates a single image in that group, according to an embodiment of the present invention.

FIG. 8 is a diagram illustrating a target image in which a person is to be estimated and an image group from the same event as that image, according to an embodiment of the present invention.

FIG. 9 is a diagram illustrating a target image in which a person is to be estimated and an example of an estimation result for that image, according to an embodiment of the present invention.

FIG. 10 is a block diagram illustrating the basic configuration in the case where estimation is carried out taking into consideration a period of time in which changes have occurred in mutual relationships between target objects, according to an embodiment of the present invention.

### DESCRIPTION OF THE EMBODIMENTS

Exemplary embodiments of the present invention will now be described in detail with reference to the drawings. It should be noted that the relative arrangement of the components, the numerical expressions and numerical values set forth in these embodiments do not limit the scope of the present invention unless it is specifically stated otherwise.

### First Embodiment

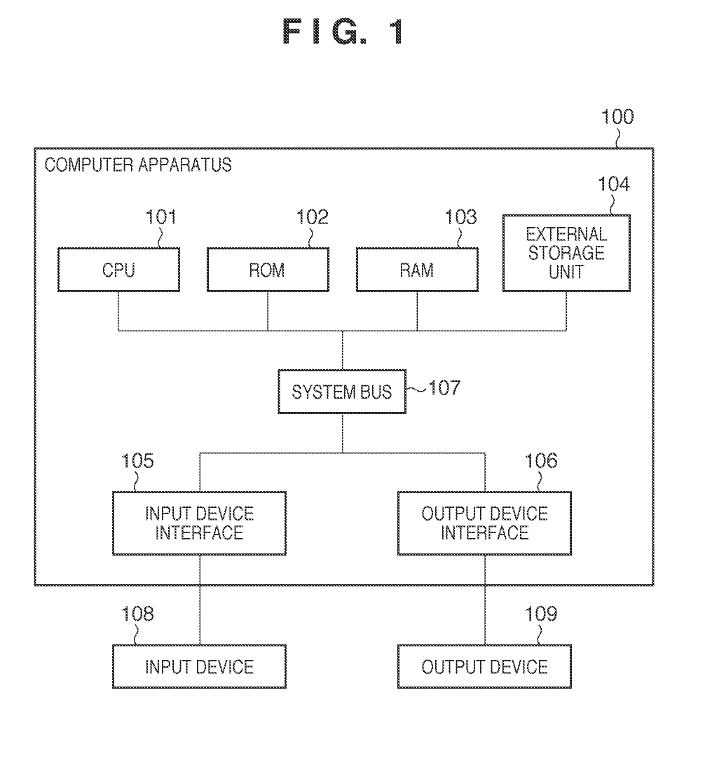

The circuit arrangement of a computer apparatus serving as an information processing apparatus according to the present embodiment will be described with reference to the block diagram illustrated in FIG. 1. This configuration may be realized by a single computer apparatus, or may be realized by distributing the various functions among multiple computer apparatuses as necessary. In the case where the configuration is realized by multiple computer apparatuses, the multiple computer apparatuses are connected to each other using a LAN or the like that is capable of communication.

In FIG. 1, a CPU 101 controls a computer apparatus 100 as a whole. A ROM 102 is a memory that stores programs, parameters, and so on that do not need to undergo changes. A RAM 103 temporarily stores programs, data, and so on supplied from an external storage device or the like. An external storage unit 104 is a hard disk, a memory card, or the like that is fixedly installed in the computer apparatus 100. Alternatively, the external storage unit 104 is a flexible disk, an optical disk such as a compact disk or the like, a magnetic or optical card, a smartcard, a memory card, or the like that is removable from the computer apparatus 100. An input device interface 105 accepts operations from a user and inputs data from an input device 109 such as a pointing device, a keyboard, or the like. An output device interface 106 outputs, to an output device 110 such as a monitor or the like, data held in the computer apparatus 100, data that has been supplied, results of executing programs, and so on. A system bus 107 connects the units 101 to 106 in a communicable state.

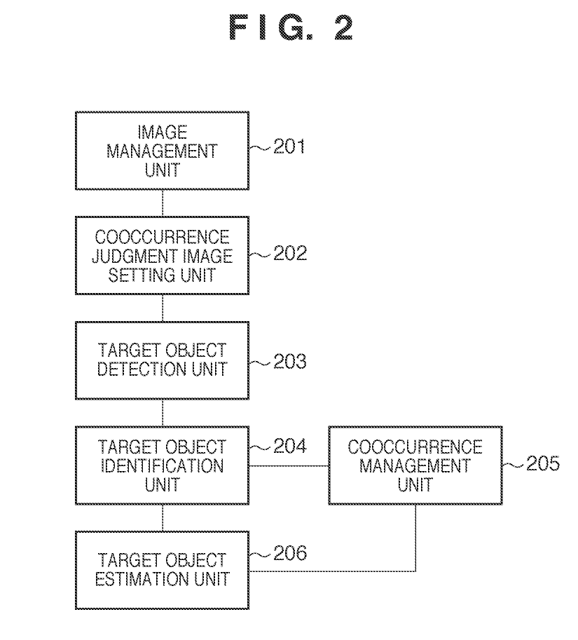

Next, the basic configuration of the information processing apparatus according to the present embodiment will be described with reference to the block diagram illustrated in FIG. 2.

An image management unit 201 adds metadata to images, and holds and manages those images. At this time, the metadata may be stored in the image data in a predetermined format, or correspondence relationships between the images and metadata may be managed and the metadata stored as separate data in the external storage unit 104.

A cooccurrence judgment image setting unit 202 sets images for carrying out a judgment as to whether or not target objects cooccur with each other. In the present embodiment, a sequential image group shot as an event occurring in an individual shooting location, such as a trip, a sports festival, or the like, is found from the images stored in the image management unit 201. These images are selected and set as images on which the cooccurrence judgment is to be carried out. This image group can be found automatically based on a distribution of metadata such as the shooting time, shooting location, and so on. For example, shooting time metadata is already added to most images. For example, a captured image whose shooting time interval is determined to be within a predetermined period based on this metadata is taken as the captured image on which the judgment as to whether or not the target objects cooccur is to be carried out for a single continuous event.

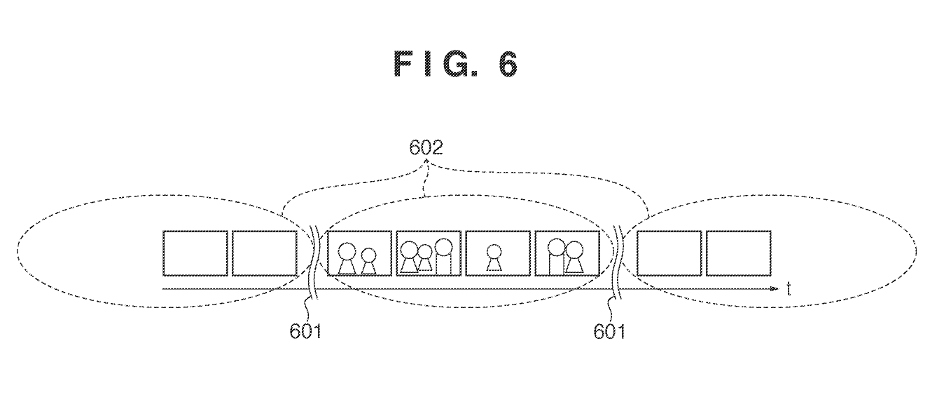

For example, FIG. 6 illustrates a case in which images managed by the image management unit 201 are arranged in time series order, and 601 indicates a location at which a shooting date/time interval exceeds a threshold. This location is used as a cutoff point to create a group of images belonging to the same event from the series of images that have been found (602). In addition to this, in the case where location information can be used in addition to the time, imbalances in distributions of geographical shooting locations are discovered, the location information is employed along with the time to find movement distances, and so on, and images captured in the same region may be taken as the captured images on which the determination as to whether or not the target objects cooccur is to be carried out.

In particular, there are cases where the image management unit 201 manages images of an event that occurred at almost the same time as another event. In this case, it is difficult to distinguish the events based only on the shooting time, and thus the management may be carried out using location information as well. However, there is at present no guarantee that location information will always be added to images. Accordingly, in the case where images from multiple events are often managed in an intermixed state as described above, measures are carried out to prevent confusion. For example, because information such as the model, type name, or the like of the shooting device is often added to images as metadata, the aforementioned event division process may be carried out having been limited to images shot by the same shooting device.

Note also that the division of images into groups based on events does not necessarily need to be carried out automatically. For example, a user can perform inputs so as to consolidate images in order to organize images on an event-by-event basis, add event names to metadata in order to consolidate images, and so on. In this manner, in the case where a user has manually input information in order to consolidate images, the input information may be used. Event information found in this manner is held as metadata for each of the images.

A target object detection unit 203 detects a region in an image in which a target object may be present. Note that in the present embodiment, the target object is assumed to be a person, and regions that are thought to be people are detected by extracting feature amounts from the image. For example, a target object may be determined to be a person using a face region detection process, or a region specified by a user may be detected as a region in which a person may be present. Note that the method for detecting the face region may be a known method. For example, there is a method that detects a face region by using color information such as the color of hair, skin, or the like, positional relationships between the constituent elements of the face, such as the eyes, the nose, and the mouth, and so on. Alternatively, there is a method in which feature amounts that enable a distinction to be made between a face and areas aside from the face are extracted in advance from multiple facial images, and a region in which the feature amounts can be calculated from an image is discovered as the face region. Any of these methods may be used in order to detect the target object in the image.

A target object identification unit 204 carries out a process for identifying whether a region of a target object detected by the target object detection unit 203 corresponds to a target object having image features that have already been registered. In the present embodiment, the detected target object is assumed to be a person. Identification is carried out by comparing image feature amounts for characteristic images of each of people that have been registered in advance with an image feature amount of the detected person and determining that the person is the same person in the case where the difference between those feature amounts is less than a predetermined threshold. The identification method may be a known method that uses information aside from feature amounts as well.

The present embodiment describes identifying a person based on a feature amount in a facial image. In other words, feature amounts of the constituent elements of the face of the person to be identified (that is, the eyes, the nose, the mouth, the contours, and so on) are learned in advance. Then, in the case where the feature amounts found from the facial image of the person that has been detected and the feature amounts of the person whose facial constituent elements have already been learned are sufficiently close in terms of values, the person is identified as the same person and output as an identified target object. In the case where the closeness to the pre-set feature amounts does not exceed the threshold, it is assumed that the person is not the same person, and the result is output as an unidentified target object. Meanwhile, in the case where there are multiple people that have closenesses that are within the threshold and it is thus difficult to uniquely identify a person, a result indicating that no identification has been made is output.

A cooccurrence management unit 205 takes target objects identified by the target object identification unit 204 as cooccurring with each other within a sequential group of images on which the cooccurrence judgment is to be carried out, and holds and manages this as mutual relationship information. In other words, a group composed of identified regions present in a single image (that is, images of cooccurring target objects) serving as elements is defined. In the present embodiment, the cooccurrence management unit 205 records the number of times target objects cooccur with each other, or in other words, an appearance number indicating a number of times identified target objects appear with each other in the image on which the identification process has been performed, as mutual relationship information.

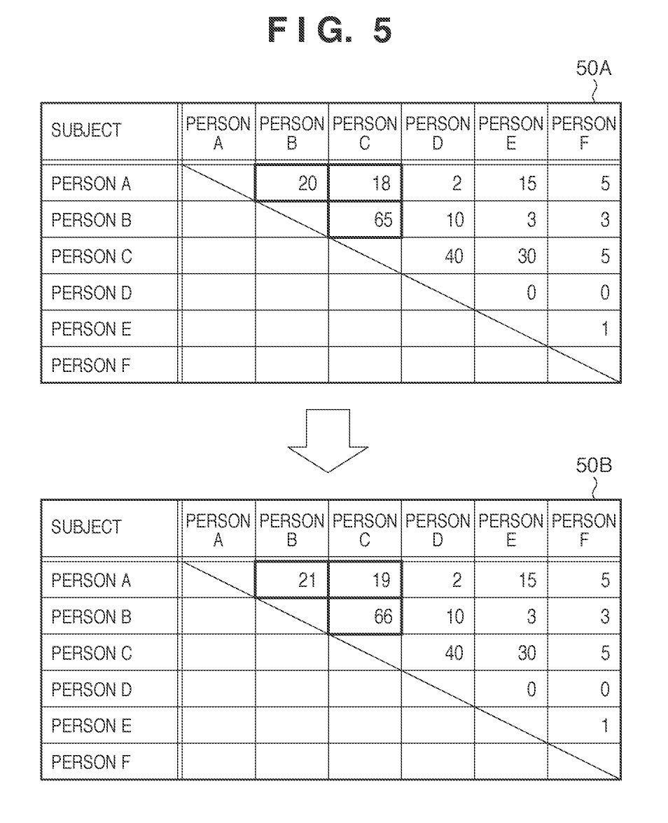

For example, the appearance number indicating the number of times the target objects cooccur with each other is managed in a table. At this time, in the case where a person A, a person B, and a person C have been identified in a sequential image group, the cooccurrence table is updated in the manner indicated by 50A and 50B in FIG. 5. In other words, the cooccurrence frequency of the person A and the person B is updated from 20 to 21, the frequency at which the person A and the person C cooccur with each other is updated from 18 to 19, and the frequency at which the person B and the person C cooccur with each other is updated from 65 to 66.

A target object estimation unit 206 estimates, in the case where there is a target object that has been identified, which identified target object a target object that could not be identified is, based on the target object or a target object that is likely to cooccur with that target object.

A target object that is likely to cooccur with the identified target object is derived from the mutual relationship information managed by the cooccurrence management unit 205. In the present embodiment, the target objects are people, and thus it is estimated “who” the person that could not be identified is. For example, in the case of the relationship having the cooccurrence indicated by 50B in FIG. 5, it is estimated that the person that is most likely to cooccur with the people A and B is the person C, based on the frequency of cooccurrences with each other.

Note that multiple people that are considered to be candidates may be given as the result of the estimation. Alternatively, in the case where the cooccurrence frequency is managed as in the present embodiment, the likelihood of cooccurrences with each other can be determined based on that frequency, and thus the people may be put in order based on the likelihood of cooccurrence, which may then be used as the result of the estimation. Furthermore, a value that is proportional to the likelihood of cooccurrence may be added to images as a degree of reliability, which may then be used as a result of the estimation.

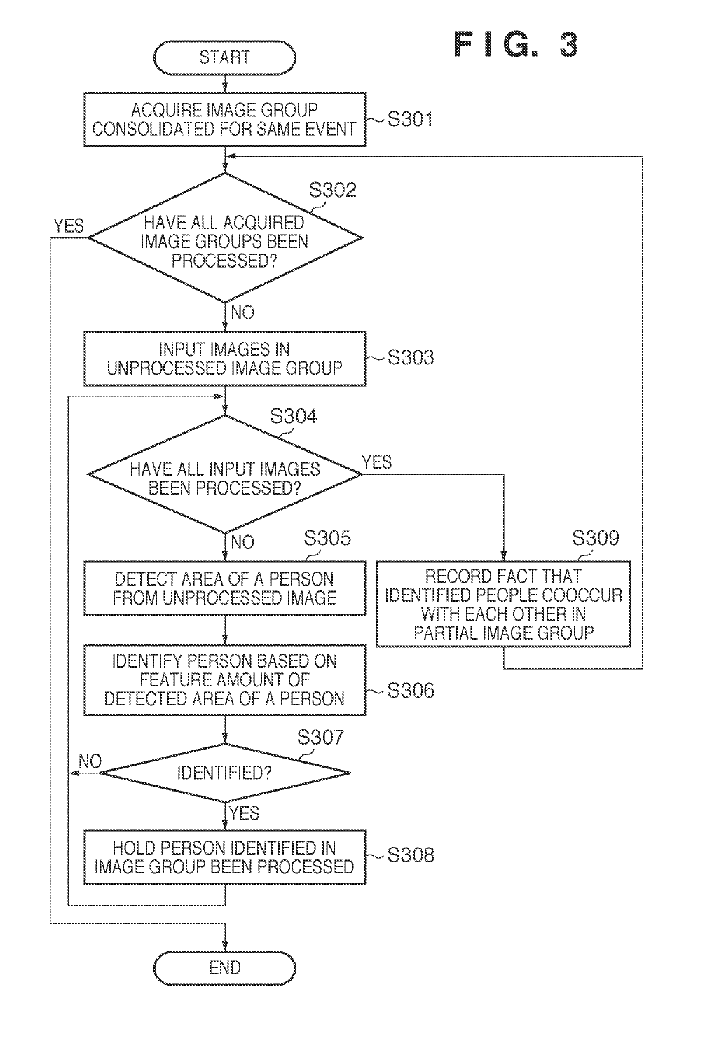

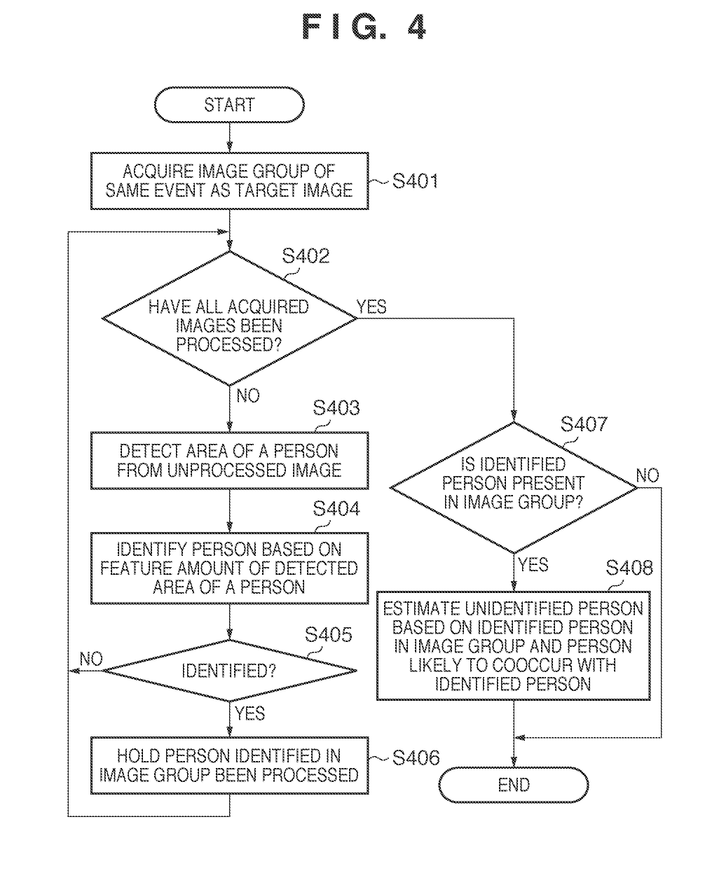

Next, a procedure of a process performed by the information processing apparatus according to the present embodiment will be described with reference to the flowchart in FIGS. 3 and 4. Note that the following flows will be described assuming that the target object is a person.

The flowchart in FIG. 3 illustrates a processing procedure for finding a mutual relationship between people according to the present embodiment.

In S301, the cooccurrence judgment image setting unit 202 acquires, from the images held in the image management unit 201, a partial image group considered to belong to the same event. Although it does depend on the images to be processed as well, at this point in time, there are cases where multiple partial image groups are found. In the present embodiment, each of the partial image groups that have been found is acquired. For example, in the case where multiple image groups have been found, as indicated by 602 in FIG. 6, the partial image groups are acquired sequentially.

In S302, it is determined whether all of the image groups acquired in S301 have been processed, and if all of the image groups have been processed, the flow ends. However, in the case where there is a partial image group that has not yet been processed, the flow advances to S303.

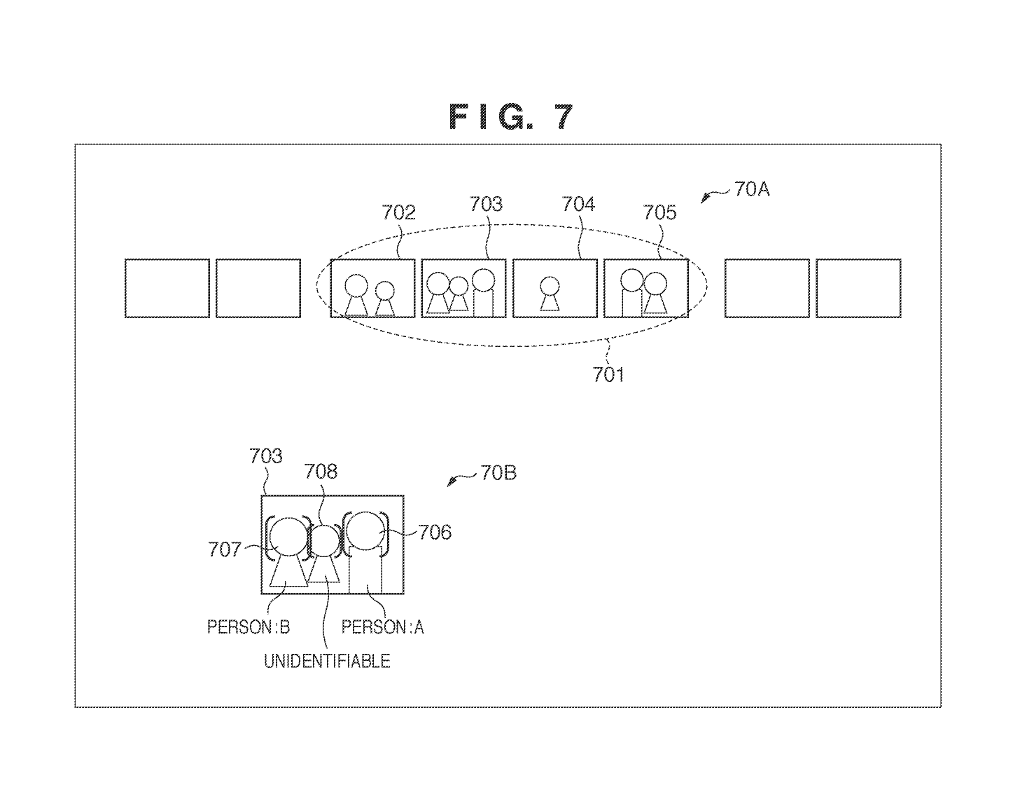

In S303, of the partial image groups found in S301, each of the images in the unprocessed image group is input. For example, assuming that 701 in the portion of FIG. 7 indicated by 70A is a partial image group, images 702 to 705, which belong to that image group, are acquired in the case where that image group has not yet been processed.

In S304, it is determined whether or not all of the images input in S303 have been processed, and if all of those images have been processed, the flow advances to S309. However, in the case where there are images that have not yet been processed, the flow advances to S305. For example, to use FIG. 7 as an example, the images indicated by 702 to 705 are processed sequentially.

In S305, the target object detection unit 203 detects regions with people in the unprocessed images from the images input in S303. For example, if the image indicated by 703 in FIG. 7 is unprocessed, that image is taken as a processing target, and regions in which a person may be present are detected to determine who the person in the image is.

In S306, the target object identification unit 204 determines who the regions of the people correspond to for the regions of the people detected in S305. The portion of FIG. 7 indicated by 70B shows a result of detecting regions of people in the image indicated by 703 and determining each of those people. Here, the people A and B have been determined as corresponding for the regions 706 and 707 including people, whereas it could not be determined who the region 708 including a person corresponds to despite a successful detection.

In S307, it is determined whether people have been identified in S306, and in the case where the people have been identified, the flow advances to S308. However, in the case where a person could not be identified, the flow returns to S304, and the processing is carried out on a different unprocessed image. To use FIG. 7 as an example again, the people A and B have been identified, and thus the flow advances to S308.

In S308, the people identified in S306 are held, as people that have been identified in the image group currently being processed, while the images in the image group are being processed. After this, the flow returns to S304, and another unprocessed image in the same image group is processed. To use the example shown in FIG. 7, the image 703 in 70B is an image within an image group 701, and thus the fact that the people A and B have been identified in the image 703 is held while the images in the image group 701 are being processed.

In S309, the cooccurrence management unit 205 stores and manages the mutual relationships of cooccurrence between the people held in the aforementioned S308 as the people cooccurring with each other in the image group that is currently being processed. As already described, in the present embodiment, the cooccurrence management unit 205 holds frequencies of cooccurrences. For example, assuming that all of the images in the image group indicated by 701 in FIG. 7 have been processed and the people A, B, and C have been identified in the process, the frequencies with which these people cooccur with each other are updated by adding the frequencies together (this corresponds to adding numerical values in the table shown in FIG. 5).

FIG. 4 is a flowchart illustrating the procedure of a process for estimating, based on the mutual relationships between people, a person that could not be identified. In this procedure, whether or not people that can be identified are present in an image belonging to an image group of an event to which an image of a person that could not be identified belongs is found, and mutual relationships with the person that could be identified are then examined. Accordingly, in the flow illustrated in FIG. 4, a single image held in the image management unit 201 is focused upon. The procedure illustrates a process carried out in the case where there is a person in the image that cannot be identified and “who” that person is is estimated based on the person that most closely resembles that person.

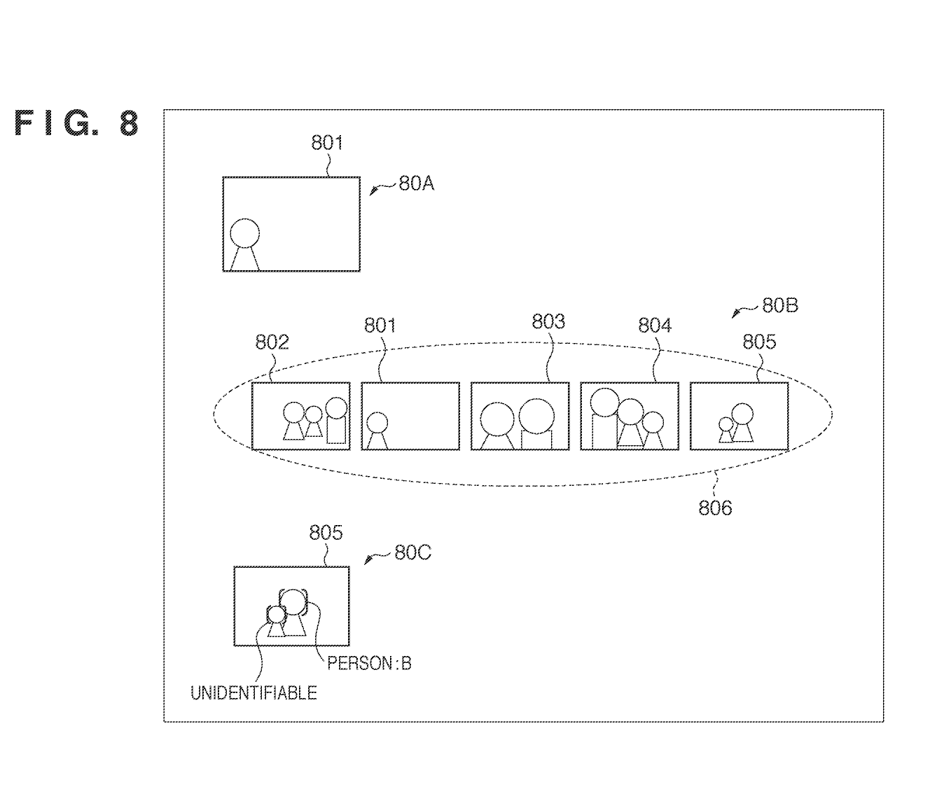

In S401, all of the images in the event to which the input target image belongs are acquired. The judgment as to whether or not an image belongs to the same event carried out at this time is performed using a judgment process similar to the process carried out by the cooccurrence judgment image setting unit 202. For example, in the case where 801 in 80A illustrated in FIG. 8 is the target image, the cooccurrence judgment image setting unit 202 finds an image group 806 of an event to which that image belongs, as indicated by 80B. Then, each of target images 801 to 805 in that image group are acquired.

In S402, it is determined whether or not all of the images acquired in S401 have been processed. If all the images have been processed, the flow advances to S407. However, in the case where there are images that have not yet been processed, the flow advances to S403.

In S403, the target object detection unit 203 detects regions with people in a single image from among the unprocessed images.

In S404, the target object identification unit 204 identifies the people detected in S403.

In S405, it is determined whether people have been identified in S404, and in the case where the people have been identified, the flow advances to S406. However, in the case where a person could not be identified, the flow returns to S402, and the processing is carried out on a different unprocessed image.

In S406, the people identified in S404 are held, as people that have been identified in the image group belonging to the same event as the event to which the target image belongs, while the image group is being processed. After this, the flow returns to S402, and the processing is carried out on a different unprocessed image.

In S407, it is determined whether or not a person identified in S406 is present in the sequential image group in the same event to which the target image belongs, and in the case where an identified person is present, the flow advances to S408. However, in the case where there is no person that has been identified, information necessary for the estimation could not be obtained, and thus the flow ends.

In S408, the target object estimation unit 206 acquires the mutual relationships for each person held in S406 from the cooccurrence management unit 205, and extracts people that are likely to cooccur with each person based on those mutual relationships. The people obtained through the aforementioned processing are then counted. In other words, in each image in the event to which the target image belongs, the appearance number indicating the number of times identified people that cooccur with the person that could not be identified (a first cooccurrence identification target object) and a person likely to cooccur with the identified people (a second cooccurrence identification target object) appears are counted. In the case where this number of appearances exceeds a predetermined number, the second cooccurrence identification target object is estimated to be a candidate for the person that could not be identified in the target image. In the case where a person that has been identified is included in the target image, that person that is the second cooccurrence identification target object is excluded from the candidates. A specific example will be described hereinafter.

For example, assume that the people that could be identified in the series of target images 801 to 805 that belong to the same event as the target image 801 are the people A and B, and the person C is a person that is likely to cooccur with those people. This corresponds to the mutual relationships illustrated in the table in FIG. 5. At this time, assuming that one person has been detected in the target image 801, and that person could not be identified and will therefore be estimated, the process is as follows.

That is, because there are no other people that could be identified in the target image 801, it is thought that the people A, B, and C are equally as likely to be the person in question, and this is taken as the result of the estimation.

On the other hand, as opposed to the target image 801, the case of the target image 805 is a case of a target image that includes both a person that could be identified and a person that could not be identified (80C in FIG. 8); the person B that could be identified is excluded, and the people that could not be identified are taken as the result of the estimation. Here, because the person B could be identified, the people that are likely to cooccur with B are A and C. In other words, the people A and C are both equally likely as candidates for the person that could not be identified, and this is taken as the estimation result.

Note that in S408, the process described in S309 is carried out for the person that was identified, and the person that was identified is then registered, whereas the person that could not be identified is then estimated. Meanwhile, although the identification of people at the time of estimation has been described as being carried out during the flow illustrated in the aforementioned FIG. 4, the present embodiment is not limited thereto.

In addition, it can be thought that the number of people that could be identified will gradually increase as a result of this estimation process, manual input, or the like. In this case, when once again carrying out the estimation process, it is not necessary to carry out a process for identifying people that have already been identified. In other words, the processes from S407 on may be carried out after the image group acquisition has been carried out in S401.

According to the first embodiment described thus far, people that could not be identified can be estimated by using imbalances in the cooccurrences of people that appear in captured images.

### Second Embodiment

In the first embodiment, the target object identification unit 204 being unsuccessful in uniquely identifying a target object was output as a result. However, in this case, information regarding the fact that a unique determination could not be made may be left. Through this, it is furthermore possible to carry out the estimation as follows.

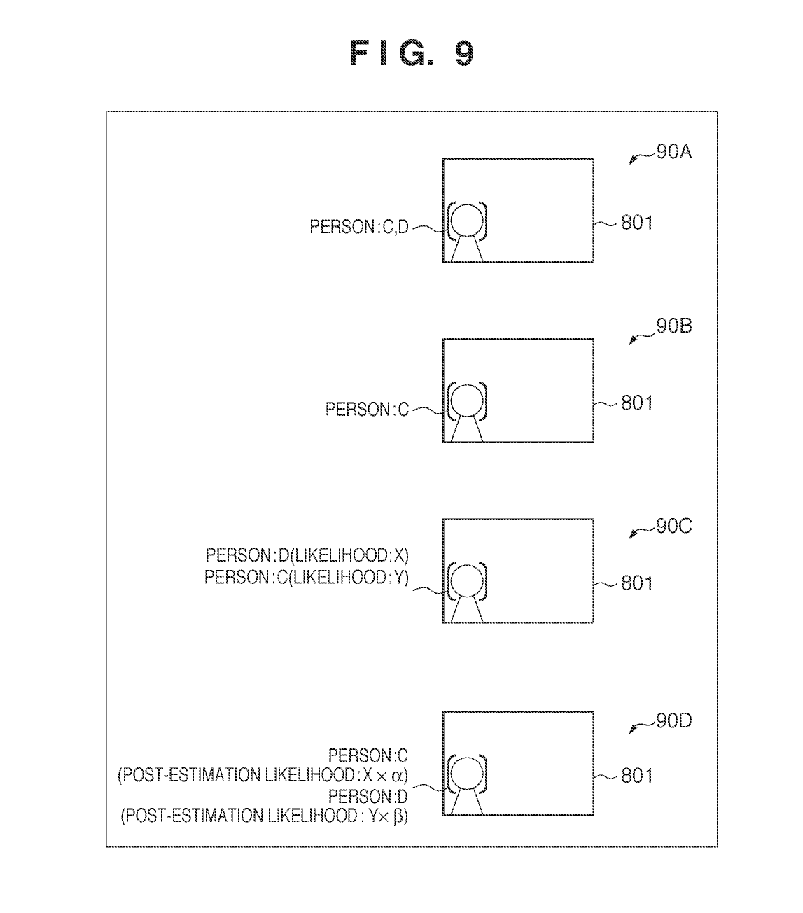

For example, in the target image 801, there is a possibility that the person that could not be identified is the person C or a person D, and it is assumed that the person that could not be identified cannot be determined to be either of those people; this is obtained as the result of the target object identification unit 204. In this case, although the result indicates that no identification could be made because no unique determination is made, information indicating that the person is the person C or the person D is left as the result. The method for leaving the result is not particularly limited here. For example, as indicated by 90A in FIG. 9, this information may be added to the image as metadata, and the people that have appeared as identification candidates may then be listed and held.

In the case where this person is the target of estimation, the target object estimation unit 206 acquires the mutual relationships between the identified people in the image group of the same event as that image from the cooccurrence management unit 205, and extracts the people that are likely to cooccur with that person. In this example, the people that have been identified are the people A and B, and thus the person C can be extracted as a person who is likely to cooccur with those people. After this, in the present embodiment, there is information indicating that the person that is the target for estimation is either the person C or the person D, and thus, as indicated by 90B in FIG. 9, this information is taken into consideration in order to obtain an estimation result indicating the person C.

Note that a list of the people that appeared as candidates is left by the target object identification unit 204 as the information indicating that a unique determination was not made. Meanwhile, as another method, in the case where the identification process calculates a likelihood for the estimation, information X and Y of that likelihood may furthermore be left, as indicated by the target image 801 in 90C in FIG. 9.

In this case, not only is the aforementioned estimation carried out, but furthermore, a certain correction may be carried out on the likelihood, and the estimation may then be carried out taking that into consideration. For example, in 90D in FIG. 9, a value in which the likelihood Y is multiplied by a constant α that is greater than 1 is calculated for the person C, who is a person who is likely to cooccur. Meanwhile, because the person D does not correspond to any of the people A, B, and C, a value in which the likelihood X is multiplied by a constant β that is less than 1 is calculated for the person D. As a result, in the case where the size relationship is Y×α>X×β, the person C is more likely.

As described thus far, in the case where some uncertainty remains in the identification result, and the likelihood of a certain target object is greater than a threshold and only a single target object that has that likelihood is present, that target object can be estimated to most likely resemble the object in question. Accordingly, the most applicable candidate from among target objects having a high likelihood for the identification result can be estimated.

### Third Embodiment

In the aforementioned first and second embodiments, the cooccurrence judgment image setting unit 202 sets, as a target for cooccurrence judgment, a serial image group in which a certain event is thought to have been shot, but the present invention is not limited thereto. This is because focusing on mutual relationships within a single image can be considered as well.

In this case, the cooccurrence judgment is not carried out with a series of images at the unit, but may instead be carried out using a single image. For example, assume that the people A and C have been identified in a certain set of multiple images, and the cooccurrence management unit 205 holds the fact that those two people are in a relationship in which they are likely to cooccur. At this time, in the case where a person that has been identified as the person A and a person that could not be identified are present in the target image, operations may be performed so as to estimate the person C as the person who is likely to cooccur with the person A.

According to the third embodiment described thus far, it is also possible to carry out estimation on a single image-by-single image basis using mutual relationships on a single image-by-single image basis.

### Fourth Embodiment

The embodiments described thus far have discussed a method in which the target object identification unit 204 determines that an identification has been successful, but the present invention is not limited thereto. For example, with respect to the target object detection unit 203, it was pointed out that a user specifies the target object, but there are also cases where the user furthermore inputs information that makes it possible to identify that target object. In the case of people, this corresponds to information indicating “who” the person is.

In other words, by receiving identification information, input by the user, that makes it possible to identify a specific target object, the identification information from the user that makes it possible to identify the target object is given priority over the result of the determination that identifies the target object based on the feature amount thereof. That target object may then be identified based on the identification information that makes the identification possible.

According to the 4th embodiment as described thus far, a target object can be estimated based on a result input by a user.

### Fifth Embodiment

Although the aforementioned embodiments primarily describe the target object as a person, the present invention is not limited thereto. Any object can be employed as the target object as long as there are imbalances in the likelihood of cooccurrences thereof. For example, the target object may be a pet. As with people, it is often the case that a pet is present with people, other pets, or the like that are likely to cooccur. For example, it can be said that a pet is likely to cooccur at least with its owner. Imbalances in cooccurrences also occur among pets that are friendly with each other. It can also be thought that imbalances in the likelihood of cooccurrences will occur even in combinations such as the friends of an owner and the owner's pets, resulting from whether those owners and pets like or dislike each other and so on.

In this case, the target object detection unit 203 also detects pets (such as dogs), and the target object identification unit 204 can then identify those pets. In the case where an identification has been made, mutual relationships are also managed for the pets. Then, the target object estimation unit 206 also estimates the pets.

With respect to the detection and identification of pets, it should be noted that in the case where there is an input from a user, that input may be used as well. Alternately, as with the case of people, the feature amounts of images of pets that are to be identified may be learned in advance, and the detection, identification, and so on may then be carried out based on whether or not there is a portion in the target image that resembles the feature amounts.

According to the fifth embodiment as described thus far, in addition to people, pets can also be used as targets for identification and estimation.

### Sixth Embodiment

In the aforementioned embodiments, the ratio of the number of target objects identified by the target object identification unit 204 relative to the number of target objects detected by the target object detection unit 203 is found. Then, in the case where that ratio is lower than a pre-set threshold, the method of estimation may be controlled. Such a case often occurs with respect to unknown target objects. In other words, it is highly likely that an imbalance in cooccurrences that cannot be estimated based on the conventional mutual relationships has taken place. Alternately, it is highly likely that target objects whose mutual relationships should normally be examined have been missed because those target objects could not be identified, and a combination that cannot be called a mutual relationship of cooccurrence will instead be examined.

Due to the above, in this case, control may be carried out so as to suppress the estimation. To be specific, the degree of reliability of the estimation result may also be presented, and that degree of reliability may be reduced proportionately to the ratio of the number of target objects that have been identified by the target object identification unit 204.

### Seventh Embodiment

In the aforementioned embodiments, the cooccurrence management unit 205 has been described as holding frequencies of cooccurring appearances, but the present invention is not limited thereto. Because the purpose of the cooccurrence management unit 205 is to manage the likelihood of cooccurrences of target objects, the cooccurrence management unit 205 may apply weighting to the held frequencies depending on the way in which the target objects appear in each of the images.

For example, with people, in the case where there is an image in which only two people appear, it is thought that the likelihood of cooccurrence is higher than a cooccurrence in which, for example, many people are present in a commemorative photograph. In this case, a constant weight is applied to the frequency, and the frequency is then held. With respect to the determination as to whether or not only two people are present, such a determination may be made in the case where, for example, the number of target objects detected in the image is two and each of those two objects has been identified. Alternately, the degree to which a person is smiling may be determined, and weighting may be applied to target objects cooccurring in an image in which the degree to which the person is smiling is high.

### Eighth Embodiment

In the aforementioned embodiments, a change in the mutual relationships from the perspective of a certain target object among the target objects to be identified may furthermore be taken into consideration, and the mutual relationships may be managed and the target objects estimated in accordance with this change. This will be described hereinafter with reference to the drawings.

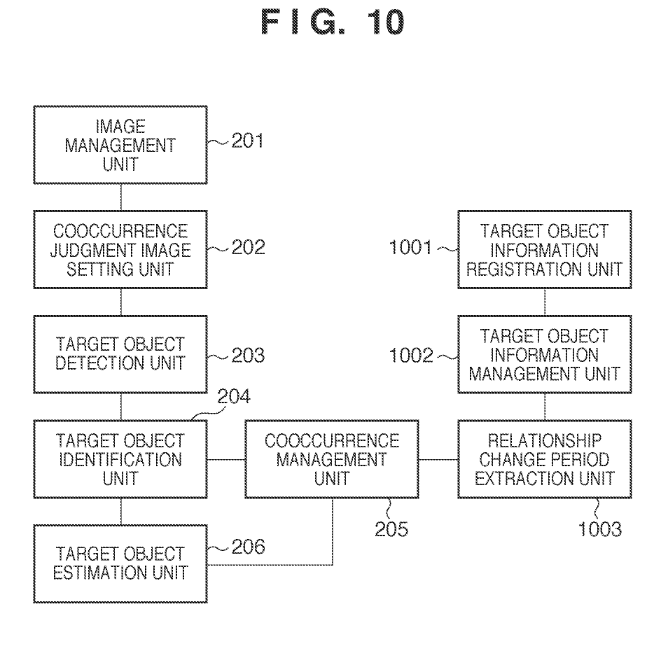

First, the circuit arrangement of the computer apparatus serving as the information processing apparatus according to the present embodiment is the same as that illustrated in FIG. 1. Next, the basic configuration of the information processing apparatus according to the present embodiment is as illustrated in FIG. 10. Here, only constituent elements that have been added to the configuration illustrated in FIG. 2 or changed from the configuration illustrated in FIG. 2 will be described, and descriptions of the constituent elements already described with reference to FIG. 2 will be omitted.

A target object information registration unit 1001 registers information of a target object to be identified. In the present embodiment, because a change in the mutual relationships from the perspective of a certain target object is taken into consideration, information regarding that target object is input.

For example, in the case where images of a family are managed, information regarding the family is input for target objects that have been registered as targets for identification, and a change in the mutual relationships between target objects in the group that is the family and outside of that group are taken into consideration. Note that for the input information of the target objects, in the case of people, dates of birth and dates of death, the dates of major events such as marriages, divorces, household moves, and so on, relationships between people such as husband and wife, parent and child, and so on are input. Furthermore, particularly when handling the structures of families, family information identifying which family the registered target object belongs to is input. In addition, the date/time when a new target object is registered, the date/time when a registered target object has died, and so on are input as well.

A target object information management unit 1002 stores and manages the information registered by the target object information registration unit 1001. Here, the registered information is managed on a target object-by-target object basis.

A relationship change period extraction unit 1003 extracts, from the information managed by the target object information management unit 1002, a period in which the mutual relationship of the target object has changed from that in the past. For example, if there is date/time information for target objects, such as a date of birth, a date of death, a date of marriage, divorce, or the like, the periods in which the target objects can cooccur with each other is predetermined. For example, because a person cannot appear before that person is born or after that person has died, those periods can be thought of as periods of relationship change.

Meanwhile, in the case where the date of birth of a child has been registered, the periods in which the child enters elementary school, enters junior high school, or the like can be estimated. Generally speaking, it is highly likely that new interpersonal relationships will occur in the family prior to and following such periods, and thus it can be thought that imbalances in cooccurrences will change. The relationship change period extraction unit 1003 may extract these periods. Note that the knowledge necessary to extract these periods is provided in advance as knowledge information. For example, in the case of a period in which a child enters elementary school in Japan, knowledge information such as “April 1 following the birthday at which the child turned six years old” is held.

Having added the above configurations, the cooccurrence management unit 205 manages the mutual relationships distinctly prior to and following the period in which a change has been determined to have occurred by the relationship change period extraction unit 1003.

Meanwhile, the target object estimation unit 206 obtains, from shooting time information of the image to be processed, information of the structure of the family, and so on, mutual relationships of the periods corresponding thereto from the cooccurrence management unit 205, and carries out the estimation. Furthermore, with respect to a registered family, in the case where there are two or more registered target objects belonging to the same family in a group including images of identified target objects as its elements, the target object estimation unit 206 may increase weighting with respect to the number of appearances in that group.

A date/time in which a registered target object does not exist may correspond to a disappearance date/time at which the target object disappeared. For example, the death of a person corresponds to such a case. For a death, the target object identification unit 204 makes a comparison with the shooting date/time contained in the metadata of the image, and in the case where the shooting date/time is newer than the disappearance date/time at which the person died, the target object identification unit 204 can operate so as not to employ that person in the identification results. The target object estimation unit 206 can also operate so as not to employ that registered target object in the estimation results.

A date/time in which a registered target object does not exist also may correspond to an appearance date/time at which the target object appeared. For example, the birth of a person corresponds to this case. For the birth of a target object, the date of birth can be compared to the shooting date/time contained in the metadata of the image, and in the case where the shooting date/time is older than the date of the birth, the target object identification unit 204 can operate so as not to employ that registered target object in the identification results. The target object estimation unit 206 can also operate so as not to employ that registered target object in the estimation results.

Through this, employing information of new mutual relationships to a sufficient degree not only gradually increases the precision of estimation, but also has an effect of increasing the speed of the improvement in the estimation precision after a change in mutual relationships has occurred.

Note that in the case where estimation is carried out using the mutual relationships as described above, the mutual relationships prior to and following the period may be used. For example, it can be thought that the mutual relationship immediately previous will also affect the mutual relationships that follow thereafter to a certain degree. Accordingly, weighting may be applied to the mutual relationships in each period so as to prioritize mutual relationships that are temporally close, and the estimation may then be carried out.

According to the embodiment described thus far, target object information that enables a more accurate estimation can be added for images in which a target object could not be identified.

### Other Embodiments

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., computer-readable storage medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-288417 filed on Dec. 18, 2009, which is hereby incorporated by reference herein in its entirety.

What is claimed is:

1. An information processing apparatus comprising:
a storage unit configured to store image features of multiple targets and mutual relationship information of the multiple targets;
an input unit configured to input an image;
a detection unit configured to detect a region of a target from the input image;
an identification unit configured to, based on the stored image features and image features of the detected region, identify the target of the region; and
an estimation unit configured to, in the case where both a first region in which a target was identified and a second region in which a target could not be identified are present in the input image, estimate a candidate for the target in the second region based on the mutual relationship information and the target in the first region.

2. The information processing apparatus according to claim 1, wherein the storage unit stores, as the mutual relationship information, a number of appearances in which each of the multiple targets appear together in multiple reference images input in advance.

3. The information processing apparatus according to claim 2, wherein the estimation unit estimates the target having the highest number of appearances with the target in the first region as a candidate for the target in the second region.

4. The information processing apparatus according to claim 2, wherein in the case where the number of targets included in the image is two, the estimation unit estimates the candidate by giving a higher weight to the number of appearances than in the case where the number of targets in the image is three or more.

5. The information processing apparatus according to claim 2, wherein metadata corresponding to the same conditions as metadata added to the input image is added to each of the multiple reference images.

6. The information processing apparatus according to claim 5, wherein in the case where the second region is present in the input image but the first region is absent from the input image, the estimation unit estimates a target that appears in the multiple reference images as a candidate for the target in the second region.

7. The information processing apparatus according to claim 5, wherein metadata indicating that the input image and the multiple reference images were shot in the same period is added to the input image and the multiple reference images.

8. The information processing apparatus according to claim 5, wherein metadata indicating that the input image and the multiple reference images were shot in the same area is added to the input image and the multiple reference images.

9. The information processing apparatus according to claim 5, wherein metadata indicating that the input image and the multiple reference images were shot by the same device is added to the input image and the multiple reference images.

10. The information processing apparatus according to claim 1,
wherein the capturing date and time when the image was captured is added to the image as metadata;
the storage unit stores a disappearance date and time indicating a date and time at which a target that had been present ceases to be present;
the identification unit determines whether each of the multiple regions corresponds to one of the targets whose stored disappearance date and time is newer than the capturing date and time of the target image; and
the estimation unit estimates the candidate from among the targets whose stored disappearance date and time is newer than the capturing date and time of the target image.

11. The information processing apparatus according to claim 1,
wherein the capturing date and time when the image was captured is added to the image as metadata;
the storage unit stores an appearance date and time indicating a date and time at which a target that had not been present starts to be present;
the identification unit determines whether each of the multiple regions corresponds to one of the targets whose stored appearance date and time is older than the capturing date and time of the target image; and
the estimation unit estimates the candidate from among the targets whose stored appearance date and time is older than the capturing date and time of the target image.

12. The information processing apparatus according to claim 1, wherein the identification unit calculates a likelihood by comparing image features extracted from the detected region with the stored image features and determines, based on the calculated likelihood, whether or not the detected region corresponds with a target that has the stored image features.

13. The information processing apparatus according to claim 12, wherein the estimation unit estimates the candidate based on the mutual relationship information and the likelihood.

14. The information processing apparatus according to claim 1, wherein the target is a person.

15. The information processing apparatus according to claim 14,
wherein the storage unit stores, as the mutual relationship information, family information identifying which family the multiple targets belong to; and
the estimation unit estimates, from among targets belonging to the same family as a target that corresponds to a region determined to correspond to one of the multiple targets, a candidate for a target that corresponds to a region in which it has been determined that the corresponding target is not present.

16. A processing method for an information processing apparatus, the method comprising:
inputting an image;
detecting a region of a target in the input image;
identifying a target in the region based on image features of multiple targets stored in a storage unit that stores the image features and mutual relationship information of the multiple targets, and based on image features of the detected region; and
estimating, in the case where both a first region in which a target was identified and a second region in which a target could not be identified are present in the input image, a candidate for the target in the second region based on the mutual relationship information and the target in the first region.

17. A non-transitory storage medium in which is stored a program that causes a computer to execute the information processing method according to claim 16.
